(19) United States
(12) Patent Application Publication
(10) Pub. No.: US 2024/0054309 A1
(43) Pub. Date: Feb. 15, 2024

(54) A METHOD FOR FORMING A NETWORK CONNECTION

(71) Applicant: AMIDO AB (PUBL), Göteborg (SE)

(72) Inventors: Andreas SELSTAM, LINDOME (SE); Peo EMGÅRD, GÖTEBORG (SE); Johnny BERLIC, GÖTEBORG (SE)

(73) Assignee: AMIDO AB (PUBL), Göteborg (SE)

(21) Appl. No.: 17/766,237

(22) PCT Filed: Oct. 5, 2020
(86) PCT No.: PCT/SE2020/050942

§ 371 Date: Apr. 2, 2022

(30) Foreign Application Priority Data
Oct. 7, 2019 (SE) 1951140-1

(51) Int. Cl. G06K 19/06; G07C 9/00; H04N 7/14

(52) U.S. Cl. CPC G06K 19/06028; G07C 9/00571; H04N 7/147; G07C 2009/00769

(57) ABSTRACT

The present disclosure relates to a computer implemented entry management method for by means of a server forming a network connection between a requesting electronic device and one of a plurality of receiving electronic devices, specifically for allowing the possibility to establish a call between the requesting electronic device and a specific one of the plurality of receiving electronic devices. The present disclosure also relates to a corresponding entry handling system and a computer program product.

### TECHNICAL FIELD

The present disclosure relates to a computer implemented entry management method for by means of a server forming a network connection between a requesting electronic device and one of a plurality of receiving electronic devices, specifically for allowing the possibility to establish a call between the requesting electronic device and a specific one of the plurality of receiving electronic devices. The present disclosure also relates to a corresponding entry handling system and a computer program product.

### BACKGROUND

In buildings shared by multiple occupants, there is often a door entry system installed, the purpose of which is to allow people to open the door entering the building from within their own unit, and to speak to people who are at the entrance of the building over an audio or video interface. The unit could be an apartment, an office, or any other piece of space requiring access control.

These systems are commonly sold as integrated solutions consisting of a door panel arranged at the entrance to the building and one or more handsets for installation within each unit, where the handsets are directly or indirectly wired to the door panel.

The cost for the owner of the building to install such an entry system is of course dependent on the number of specific occupants of the building. In addition, any upgrade of the system (involving means arranged in the occupant's premise) will result in a need for the owner to access the premises of the multiple occupants. Still further, such a static system will not allow for easy addition of further occupants, since the door panel normally is limited to a predefined number of occupants. A further limitation with present entry system is the positioning of the handset within the premise of the occupant. For example, an occupant must be physically present at within his premise to be able to connect to a person at the door panel at the entrance of the building.

With this in mind, it would be desirable to present a new type of entry handling system, reducing the limitations and disadvantages with the present type of solutions, specifically focusing on a reliable solution having an in comparison low installation and operational cost.

### SUMMARY

According to an aspect of the present disclosure, the above is at least partly met by a computer implemented entry management method for forming a network connection between a requesting electronic device and one of a plurality of receiving electronic devices using a server, the method comprising the steps of receiving, at the server, an identifier for each of the plurality of receiving electronic devices, generating, using the server, a plurality of different machine-readable codes being individual for each of the plurality of identifiers for the respective plurality of receiving electronic devices, forming, using the server, a graphical displayable representation of the plurality of different machine-readable codes, receiving, at the server and from the requesting electronic device, a representation of one of the plurality of different machine-readable codes, identifying, using the server, one specific receiving electronic device based on the received machine-readable code, and establishing, using the server, the network communication between the requesting electronic device and the one specific receiving electronic device.

By means of the present disclosure, it will be possible to greatly reduce the amount of hardware needed for providing a door entry functionality at e.g. a building comprising a plurality of different occupants. This is in line with the present disclosure achieved by arranging a server to form a plurality of different machine-readable codes being individual for each of e.g. a plurality of occupants. The different machine-readable codes may then be read by e.g. a person at the entry having a requesting electronic device and wanting to get in contact with a specific one of the occupants having a receiving electronic device, whereby the machine-readable code may be used for establishing a network connection between the person at the entry and the specific one of the occupants using their respective electronic devices. A direct communication may thus be established between the between the person at the entry and the specific one of the occupants. Such communication must not necessarily be routed through the server, rather once the network connection has been established the communication between the person at the entry and the specific one of the occupants may take place without further involvement of the server.

It should be noted that even though the present disclosure is here presented in relation to an example of a building comprising a plurality of different occupants (each provided with a receiving electronic device) and a person at an external entry door of the building (provided with a requesting electronic device), other implementations are possible and within the scope of the present disclosure. For example, the method according to the present disclosure may be used in relation to any form of entry management where there is a desire to form a “one to a selected one of many communication”.

Preferably, the machine-readable code may be a barcode, such as a QR code. However, the machine-readable code may in line with the present disclosure be arranged in any shape or form that may be read by a machine (e.g. using a camera or similar). As is known by the skilled person, the concept of barcodes includes both 2A and 3D barcodes, where the QR code is an illustrative example.

The machine-readable code, such as the code, may in some embodiments e.g. printed on a piece of paper and displayed at the entry of the building, allowing the person at the entry to use e.g. a mobile device equipped with a camera to automatically read the information. The mobile device may then establish a connection with the server, which in turn connects to the specific occupant associated with the barcode. That said, in some embodiments it may be desirable to display the machine-readable code at a display device, such as a display screen, arranged at the entrance. Using a display screen may in some situations be advantageous, since further information that is displayed in conjunction with the machine-readable codes (such as name of the occupants) may be swiftly and remotely changed in case of the occupant moving to or from the building. The server may in such an embodiment initiate a “call” between the mobile device of the person at the entry and a mobile device of the specific occupant. Once the call has been initiated, the server may be arranged to have no relation to the call. That is, the call must not be routed through the server, but rather being a direct line of communication between the mobile device of the person at the entry and a mobile device of the specific occupant.

In an embodiment, the network communication between the requesting electronic device and the one specific receiving electronic device is adapted for allowing at least one of audio and visual communication between a user of the requesting electronic device and a user of the one specific receiving electronic device. As such, the occupant may for example be presented with a video stream of the person at the entry, or solely with an audio stream from the same. The video/audio may of course also be transmitted from the occupant to the person at the entry.

In some embodiments of the present disclosure the server comprises at least a first and a second server component. That is, the functionality provided by the server may be split between numerous server components, for example a first server component for forming the network connection between the person at the entry and the occupant, and a second server component to be used for providing the audio/video communication between the person at the entry and the occupant.

Still further, in some embodiments the server is arranged in communication with a passage arrangement and the one specific receiving electronic device is adapted to control the passage arrangement when the network communication between the requesting electronic device and the one specific receiving electronic device has been established. Accordingly, it could in some embodiments be possible for the occupant using his electronic device to e.g. operate the entry door using the passage arrangement. As such, the passage arrangement may for example comprise an electrically controllable door lock and the one specific receiving electronic device is adapted to control the electrically controllable door lock.

That said, in the context of the invention, the term “passage arrangement” is meant to comprise electric, electronic or mechatronic locking units and, in particular, locks. In this respect, electronic entry arrangement can comprise various components such as, e.g., read-out means for identification media, particularly electronic keys, a locking electronics system and the like.

In line with the present disclosure, the server may thus be connected with the receiving electronic device operated by the specific occupant as well as the e.g. electronic lock. Once the occupant has decided that the person at the entry should be allowed to pass through the entry door, the receiving electronic device may be adapted to allow the electronic lock to be unlocked.

Preferably, the identifier comprises at least one of a phone number and an IP address, where the phone number and/or the IP address is associated with a specific occupant. In accordance to the present disclosure, the server will form the discussed communication between the person at the entry and the specific occupant using the identifier. That said, it may be desirable to allow the identifier to be selected as relating to e.g. the phone number and/or the IP address. Specifically, to ensure privacy of the occupants it may be desirable to form the machine-readable code based on such information, rather than directly disclosing the information. Accordingly, the server may for example be arranged to apply a one-way functionality, such as a hash functionality, to ensure that the information of the occupants may not be directly extracted from the machine-readable code.

In some embodiments of the present disclosure, the network communication between the requesting electronic device and the one specific receiving electronic device is only established if the requesting electronic device is within a predefined geographical area. For example, the requesting electronic device may be required to be equipped with means for disclosing its present geographical location. As such, a geo-fencing approach may be applied such that the requesting electronic device only may use the machine-readable code for contacting the receiving electronic device if the requesting electronic device is at a predefined desired location.

As an optional implementation of the present disclosure where a display screen is used, it maybe possible to allow the machine-readable codes to be dynamically updated at a desired time interval (e.g. every 10 seconds-10 hours, while both shorter and longer is possible). Such an implementation could possibly ensure that the requesting electronic device must be present at the display screen (typically being arranged in a vicinity of the entry door of the building) for contacting the receiving electronic device. As understood, in such an implementation it may be possible to ensure that e.g. a “copied old machine-readable code” is not valid to be used once “expired” (i.e. a new machine-readable code has been formed).

Furthermore, in one embodiment the network communication between the requesting electronic device and the one specific receiving electronic device is only established between a predefined time interval. Accordingly, in line with the present disclosure it may be possible to control when the requesting device is allowed to contact the specific receiving electronic device(s). Thus, it may be possible for each of the receiving electronic devices to possibly individually controlling when a connection is to be allowed to be established, e.g. ensuring that no one is allowed contact during e.g. the night, outside business hours, etc. Furthermore, this control functionality may also be used for allowing requests outside the predefined time frame to be optionally re-routed to e.g. a call service, etc.

In a further alternative embodiment of the present disclosure it may be possible to allow the requesting electronic device to scan the graphical representation such that e.g. “buttons” in a GUI may be selected for connecting to one of the plurality or receiving electronic devices. The GUI may be formed in an augmented or virtual reality manner, where e.g. a video stream captured using a camera of the requesting electronic device is overlaid with the GUI information as suggested above. Such an implementation could possibly increase the ease of operating the requesting electronic device.

According to another aspect of the present disclosure there is provided an entry handling system comprising a server, wherein the system is adapted to receive, at the server, an identifier for each of the plurality of receiving electronic devices, generate, using the server, a plurality of different machine-readable codes being individual for each of the plurality of identifiers for the respective plurality of receiving electronic devices, form, using the server, a graphical displayable representation of the plurality of different machine-readable codes, receive, at the server and from the requesting electronic device, a representation of one of the plurality of different machine-readable codes, identify, using the server, one specific receiving electronic device based on the received machine-readable code, and establish, using the server, the network communication between the requesting electronic device and the one specific receiving electronic device. This aspect of the present disclosure provides similar advantages as discussed above in relation to the previous aspect of the present disclosure.

According to a still further aspect of the present disclosure there is provided a computer program product comprising a non-transitory computer readable medium having stored thereon computer program means for operating an entry handling system, wherein the system comprises a server, and the computer program product comprises code for receiving, at the server, an identifier for each of the plurality of receiving electronic devices, code for generating, using the server, a plurality of different machine-readable codes being individual for each of the plurality of identifiers for the respective plurality of receiving electronic devices, code for forming, using the server, a graphical displayable representation of the plurality of different machine-readable codes, code for receiving, at the server and from the requesting electronic device, a representation of one of the plurality of different machine-readable codes, code for identifying, using the server, one specific receiving electronic device based on the received machine-readable code, and code for establishing, using the server, the network communication between the requesting electronic device and the one specific receiving electronic device. Also this aspect of the present disclosure provides similar advantages as discussed above in relation to the previous aspects of the present disclosure.

A software executed by the server for operation in accordance to the present disclosure may be stored on a computer readable medium, being any type of memory device, including one of a removable nonvolatile random-access memory, a hard disk drive, a floppy disk, a CD-ROM, a DVD-ROM, a USB memory, an SD memory card, or a similar computer readable medium known in the art.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates an entry handling system according to a currently preferred embodiment of the present disclosure, and

FIG. 2 shows a flow chart of a method according to an embodiment of the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

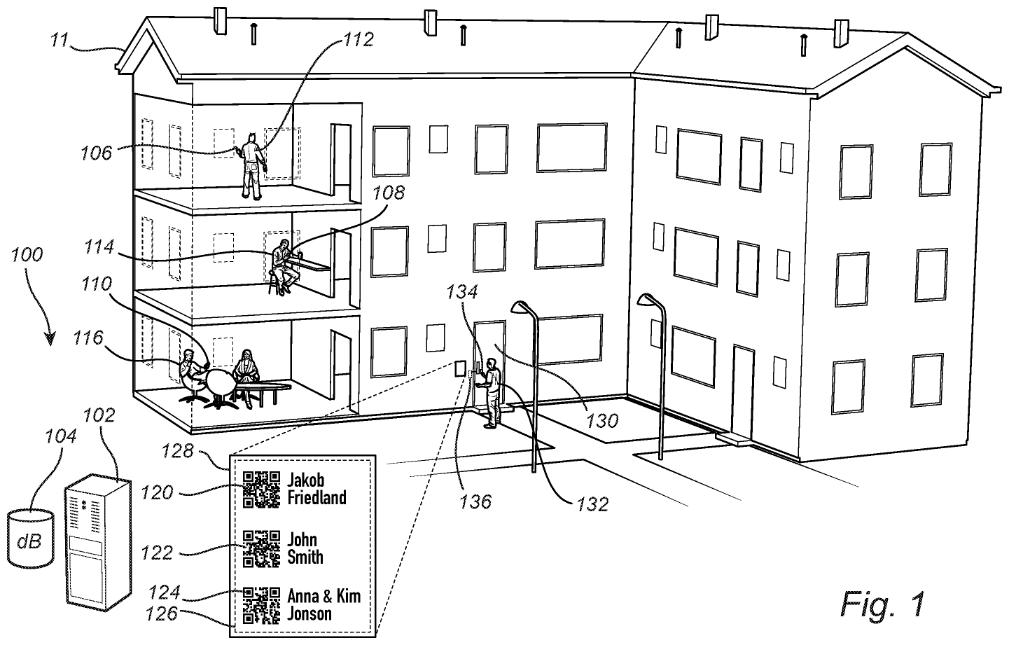

Referring now to the drawings and to FIG. 1 in particular, there is depicted an entry handling system 100 according to a possible embodiment of the present disclosure. The entry handling system 100 comprises a server 102 and a database 104 arranged in communication with each other. The server 102 is arranged in networked communication with a first, a second and a third receiving electronic user device 106, 108, 110, each operated by a first 112, a second 114 and a third 116 person being an occupant of a building 118 where for which the entry handling system 100 is provided. It should be understood that more or less than three receiving electronic user devices may be used in relation to the entry handling system 100.

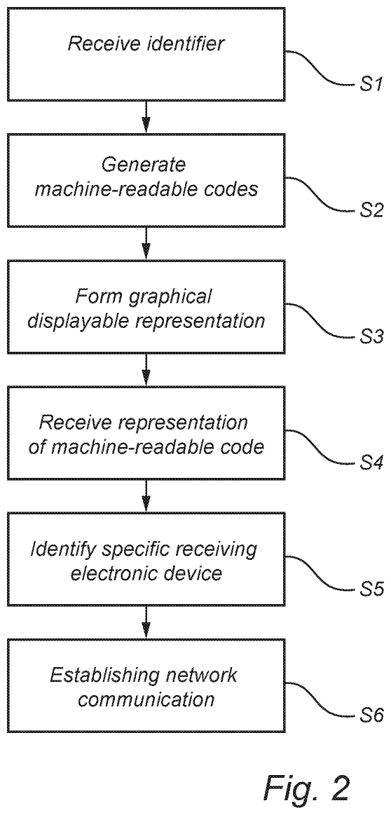

During operation of the entry handling system 100, with further reference to FIG. 2, the server 102 receives, S1, an identifier for each of the plurality of receiving electronic devices 106, 108, 110. The identifier may for example be a phone number of an IP address associated with each of the receiving electronic devices 106, 108, 110.

The server 102 will subsequently generate, S2, a plurality of different machine-readable codes 120, 122, 124 being individual for each of the plurality of identifiers. As indicated above, the machine-readable codes 120, 122, 124 may possibly be a barcode, such as a so called QR code. Based on the machine-readable codes 120, 122, 124 the server 102 will form, S3, a graphical displayable representation 126 comprising the plurality of different machine-readable codes 120, 122, 124.

In the illustration shown in FIG. 1, the server 102 is arranged in networked communication with a display unit 128 arranged at an entry door 130 of the building 118. According to the exemplifying illustration, the graphical displayable representation 126 will be displayed at the display screen 128 at the entry door 130 of the building, for anyone to see typically being outside of the door 130 of the building 118.

Once a person 132 wanting to access the building 118, or at least to get in contact with one of the occupants 112, 114, 116, the person 132 uses his (here defined as) requesting electronic device 134, such as a mobile phone, and scans an area of the graphical displayable representation 126 corresponding to one specific occupant of the building 118. The process of scanning the relevant machine readable-code corresponding to the specific occupant will initiate a contact between the requesting electronic device 134 and the server 102, whereby the server 102 will receive, S4, a representation of one of the plurality of different machine-readable codes (corresponding to the specific occupant of the building 118).

Based on the information comprised in the representation of the machine-readable code, the server 102 will identify, S5, one specific receiving electronic device (such as e.g. device 106) of the plurality of receiving electronic user devices 106, 108, 110. Such an identification may for example take place by using information stored in the database 104, where the database 104 for example may hold a “matching table” comprising the identifiers and a relation to the corresponding machine-readable codes.

Once the server has identified the specific one receiving electronic device 106, the server 102 may establish, S6, a network communication between the requesting electronic device 134 and the one specific receiving electronic device 106.

The network communication between the requesting electronic device 134 and the one specific receiving electronic device 106 may subsequently be used for allowing audio and/or video communication between the person 132 (controlling the requesting electronic device 134) and the occupant 112 (controlling the one specific receiving electronic device 106).

The network communication between the requesting electronic device 134 and the one specific receiving electronic device 106 may further be used for controlling e.g. an electronic lock 136 arranged at the door 130 of the building 118, where the electronic lock 136 is network connected to the server 102. For example, in case the one specific receiving electronic device 106 has established that the “correct” person should be given access to the building 118, he may unlock the door 130. Other functionality may of course be allowed to be controlled in a similar manner, such as controlling a light in a vicinity of the door 130, physically opening the door 130 using mechanical means, etc.

The operation of the requesting electronic device 134 and the plurality of receiving electronic devices 106, 108, 110 has been provided in general terms and in relation to any type of electronic device that may be operated by a user/person. Present and future e.g. mobile electronic devices are specifically useful in relation to the present disclosure, such as e.g. a mobile phone.

That said, the electronic devices 106, 108, 110 may include any form of computational equipped device, sch as including tablets, personal computers, etc. The networked connection may be in part be wired or wireless, including for example wired connections like a building LAN, a WAN, an Ethernet network, an IP network, etc., and wireless connections like WLAN, CDMA, GSM, GPRS, 3G mobile communications, 4G mobile communications, Bluetooth, infrared, or similar.

The server 102 may in one embodiment be a cloud-based server. Thus, the computing power provided by means of the present disclosure may be distributed between a plurality of servers, and the location of the servers must not be explicitly defined. Advantageous following the use of a cloud-based solution is also the inherent redundancy achieved.

In a preferred implementation of the present disclosure it may be possible to enrich the electronic devices 106, 108, 110, 134 with e.g. a dedicated application (App) comprising a graphical user interface (GUI) provided and at least partly executed at the respective electronic device 106, 108, 110, 134. The App of the requesting electronic device 134 may for example be provided with a connection to a camera that may be used for scanning/reading the machine-readable code and for subsequently controlling the communication with the receiving electronic device(s). In a corresponding manner, the receiving electronic devices 106, 108, 110 may have a dedicated App that allows the control of e.g. the door lock 136, etc.

In summary, the present disclosure relates to computer implemented method for forming a network connection between a requesting electronic device and one of a plurality of receiving electronic devices using a server, specifically for allowing the possibility to establish a call between the requesting electronic device and a specific one of the plurality of receiving electronic devices. The present disclosure also relates to a corresponding entry handling system and a computer program product.

By means of the present disclosure, it will be possible to greatly reduce the amount of hardware needed for providing a door entry functionality at e.g. a building comprising a plurality of different occupants. This is in line with the present disclosure achieved by arranging a server to form a plurality of different machine-readable codes being individual for each of e.g. a plurality of occupants. The different machine-readable codes may then be read by e.g. a person at the entry having a requesting electronic device and wanting to get in contact with a specific one of the occupants having a receiving electronic device, whereby the machine-readable code may be used for establishing a network connection between the person at the entry and the specific one of the occupants using their respective electronic devices.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Although the figures may show a sequence the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A computer implemented entry management method for forming a network connection between a requesting electronic device and one of a plurality of receiving electronic devices using a server, the method comprising:
receiving, at the server, an identifier for each of the plurality of receiving electronic devices,
generating, using the server, a plurality of different machine-readable codes being individual for each of the plurality of identifiers for the respective plurality of receiving electronic devices,
forming, using the server, a graphical displayable representation of the plurality of different machine-readable codes,
receiving, at the server and from the requesting electronic device, a representation of one of the plurality of different machine-readable codes,
identifying, using the server, one specific receiving electronic device based on the received machine-readable code, and
establishing, using the server, the network communication between the requesting electronic device and the one specific receiving electronic device.

2. The method according to claim 1, wherein the network communication between the requesting electronic device and the one specific receiving electronic device is adapted for allowing at least one of audio and visual communication between a user of the requesting electronic device and a user of the one specific receiving electronic device.

3. The method according to claim 1, wherein the server comprises at least a first and a second server component.

4. The method according to claim 1, wherein the machine-readable code is a barcode.

5. The method according to claim 1, wherein the server is arranged in communication with a passage arrangement and the one specific receiving electronic device is adapted to control the passage arrangement when the network communication between the requesting electronic device and the one specific receiving electronic device has been established.

6. The method according to claim 5, wherein the passage arrangement comprises an electrically controllable door lock and the one specific receiving electronic device is adapted to control the electrically controllable door lock.

7. The method according to claim 6, further comprises the step of displaying, using a display screen arranged communication with the server, the graphical displayable representation, wherein the display screen arranged is arranged in a vicinity of the electrically controllable door lock.

8. The method according to claim 1, wherein the identifier comprises at least one of a phone number and an IP address.

9. The method according to claim 1, wherein the requesting electronic device and the plurality of receiving electronic devices comprises mobile phones.

10. The method according to claim 1, wherein the network communication between the requesting electronic device and the one specific receiving electronic device is only established if the requesting electronic device is within a predefined geographical area.

11. The method according to claim 1, wherein the network communication between the requesting electronic device and the one specific receiving electronic device is only established between a predefined time interval.

12. An entry handling system comprising a server, wherein the system is adapted to:
receive, at the server, an identifier for each of the plurality of receiving electronic devices,
generate, using the server, a plurality of different machine-readable codes being individual for each of the plurality of identifiers for the respective plurality of receiving electronic devices,
form, using the server, a graphical displayable representation of the plurality of different machine-readable codes,
receive, at the server and from the requesting electronic device, a representation of one of the plurality of different machine-readable codes,
identify, using the server, one specific receiving electronic device based on the received machine-readable code, and
establish, using the server, the network communication between the requesting electronic device and the one specific receiving electronic device.

13. The system according to claim 12, wherein the network communication between the requesting electronic device and the one specific receiving electronic device is adapted for allowing at least one of audio and visual communication between a user of the requesting electronic device and a user of the one specific receiving electronic device.

14. The system according to claim 12, wherein the server is arranged in communication with a passage arrangement and the one specific receiving electronic device is adapted to control the passage arrangement when the network communication between the requesting electronic device and the one specific receiving electronic device has been established.

15. The system according to claim 14, wherein the passage arrangement comprises an electrically controllable door lock and the one specific receiving electronic device is adapted to control the electrically controllable door lock.

16. The system according to claim 15, further comprising a display screen arranged communication with the server for displaying the graphical displayable representation, wherein the display screen is positioned in a vicinity of the electrically controllable door lock.

17. The system according to claim 12, wherein the identifier comprises at least one of a phone number and an IP address.

18. The system according to claim 12, wherein the requesting electronic device and the plurality of receiving electronic devices comprises mobile phones.

19. A computer program product comprising a non-transitory computer readable medium having stored thereon computer program means for operating an entry handling system, wherein the system comprises a server, and the computer program product comprises:
code for receiving, at the server, an identifier for each of the plurality of receiving electronic devices,
code for generating, using the server, a plurality of different machine-readable codes being individual for each of the plurality of identifiers for the respective plurality of receiving electronic devices,
code for forming, using the server, a graphical displayable representation of the plurality of different machine-readable codes,
code for receiving, at the server and from the requesting electronic device, a representation of one of the plurality of different machine-readable codes,
code for identifying, using the server, one specific receiving electronic device based on the received machine-readable code, and
code for establishing, using the server, the network communication between the requesting electronic device and the one specific receiving electronic device.
